(19) United States
(12) Patent Application Publication
(10) Pub. No.: US 2008/0289406 A1
(43) Pub. Date: Nov. 27, 2008

(54) GROUP FOR MEASURING PHYSICAL PARAMETERS RELATING TO A STATE OF A TIRE

(75) Inventors: ANDREA BENATTI, CARPI (MODENA) (IT); ROMANO BERNARDUCCI, CORREGGIO (IT)

Correspondence Address: PEARNE & GORDON LLP, 1801 EAST 9TH STREET, SUITE 1200, CLEVELAND, OH, 44114-3108, US

(73) Assignee: ZADI S.P.A., CARPI (MODENA) (IT)

(21) Appl. No.: 12/116,481

(22) Filed: May 7, 2008

(30) Foreign Application Priority Data
May 24, 2007 (IT) MO2007A000177

(51) Int. Cl. G01L 17/00

(52) U.S. Cl. 73/146.3

(57) ABSTRACT

A group for measuring physical parameters relating to a state of a tire, comprising: an internal panel comprising at least a sensor, means for fixing for removably connecting the internal panel to a groove of a rim. The means for fixing comprise: a support element, solidly associable to the rim, and means for connecting predisposed to realize a reversible elastic coupling between the support element and the internal panel.

### BACKGROUND OF THE INVENTION

The invention relates to a group for measuring physical parameters relating to a state of a tire.

In particular, the invention relates to a group for measuring the temperature and pressure internally of the tires of a motor vehicle.

Systems for controlling the internal pressure of tires of vehicles are known as TPMS, an acronym of “Tire Pressure Measurement System”. Systems of this type have become widely used as a response to progressively more stringent safety measures applied in the automotive sector. The use of TPMS devices is also growing in the motor-cycle sector, where continuous control of the state of the tires is fundamental to guaranteeing stability, safety and good performance of the motorcycle.

TPMS systems can adopt two alternative techniques for reading the internal pressure of the tire: either an indirect measurement based on the acquisition of the value of the circumferential measurement of the tire, or a direct measurement via internal sensors in radio-communication with an external panel. The second system, which incurs higher costs, guarantees a more precise measurement of the pressure characteristics and the internal temperature of the tire.

In applying the technique of direct measurement, the problem of fixing the sensor elements internally of the tire has to be overcome. In TPMS systems in the prior art, an internal panel comprising the sensor elements is either fixed to the surface of the rim by an elastic band or by gluing, or is screwed into the inflation valve of the tire.

A problem common to the above-described fixing systems relates to the vibrations transmitted by the rim to the panel housing the internal sensor equipment. These vibrations can damage the sensors or the electronics attached thereto, and might also cause detachment of the panel from the surface of the rim, especially in a case in which the panel is connected by a belt or by glue. In a case in which it is screwed onto the body of the valve, the vibrations are transmitted to the valve too, and can cause damage thereto.

A further disadvantage of the fixing systems of the prior art derives from the relative complexity of the mounting of the sensor to the tire. This disadvantage is particularly present during operations in which the internal panel is being replaced, which occurs for example when the battery is exhausted.

A further limitation of the known-type fixing systems is the need to produce dedicated TPMS groups for each different measurement of rim on the market. These elements have different standardized sizes, with diameters that vary between 14 and 19 inches. In the prior art, internal panels of different sizes are realized for the various diameters.

The aim of the present invention is to realize a group for measuring physical parameters relating to a state of a tire, which group can be associated internally of the tire itself such as to obtain a considerable cushioning of the vibrations transmitted by the wheel to the internal panel of the group.

An advantage of the present device relates to the rapidity with which the coupling and uncoupling operations of the internal panel of the group to and from the rim of the vehicle it is applied to can be performed.

A further advantage of the device of the present invention relates to the adaptability thereof to rims of different types having different diameters, even considerably different from one another.

A further advantage of the present invention relates to the simplicity thereof and the modest costs for realizing it.

### BRIEF DESCRIPTION OF THE DRAWINGS

Further characteristics and advantages will better emerge from the detailed description that follows of some preferred embodiments, made herein below with reference to the accompanying figures of the drawings, in which:

FIG. 1 is an exploded perspective view of the elements of a group according to the present invention for measuring physical parameters of a stage of a tire, associated to an internal surface of a rim;

FIG. 2 is a section view of the device of the invention associated to a rim;

FIG. 3 is a perspective view of means for fixing the internal panel of the device to the rim;

FIG. 4 is a lateral view of the device of the invention in a stage of coupling the internal panel to the means for fixing to the rim.

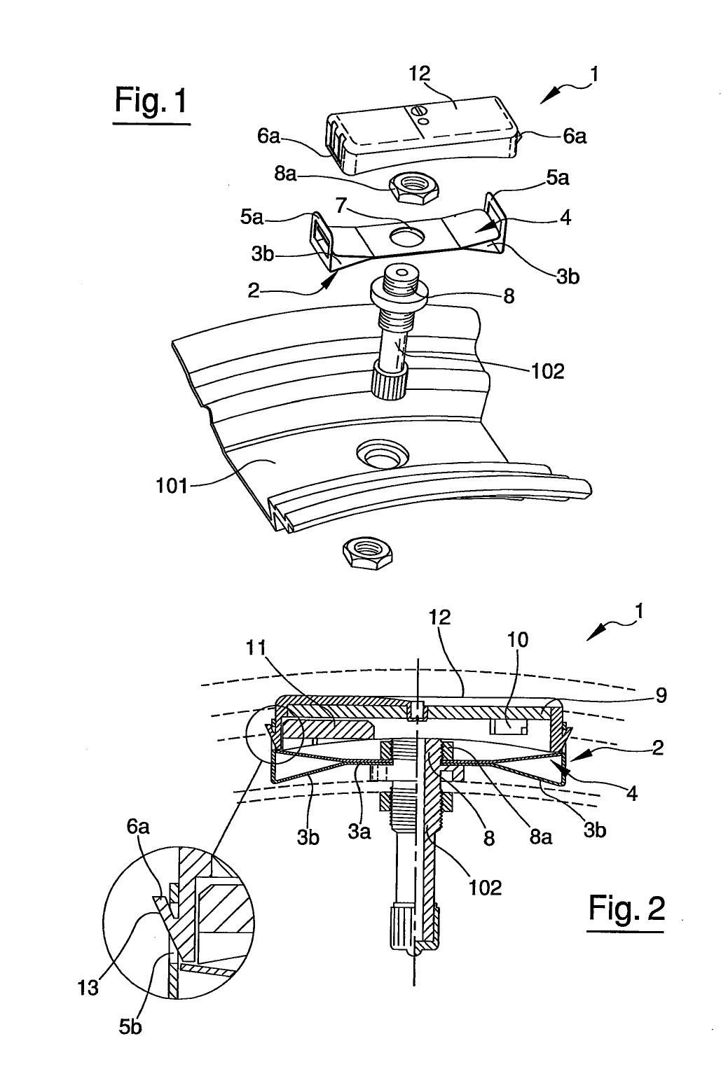

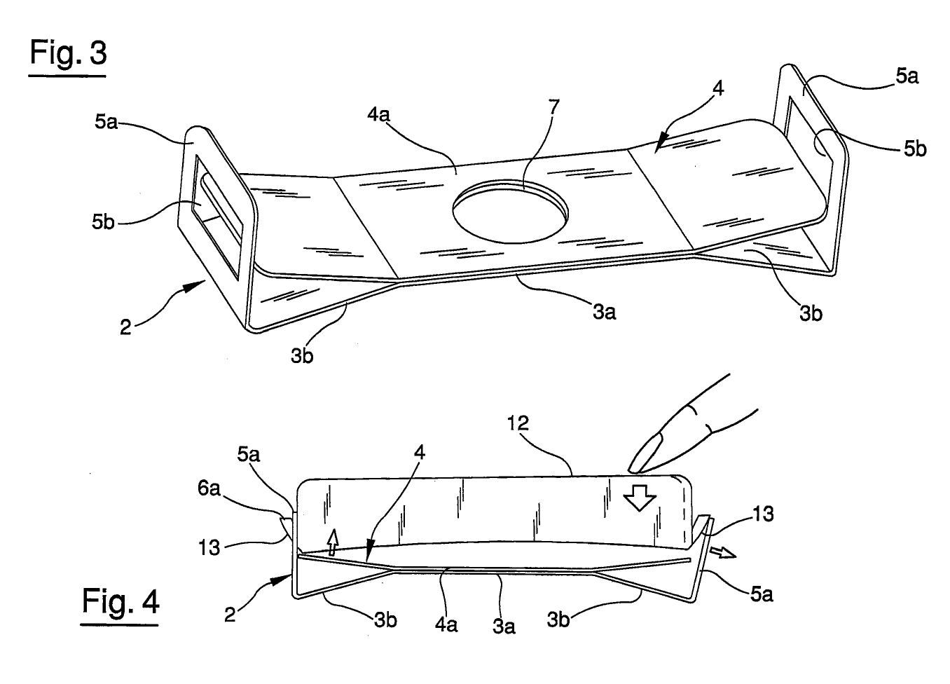

### DESCRIPTION of the PREFERRED EMBODIMENTS

With reference to the figures of the drawings, a group for measuring physical parameters of a stage of a tire is illustrated, comprising an internal panel 1 in turn comprising at least a sensor 10 and means for fixing for removable coupling of the internal panel 1 to the groove of a rim 101. The at least a sensor 10 is predisposed to perform at least pressure measurements. The at least a sensor 10 can advantageously be predisposed to perform temperature measurements too.

The above-mentioned means for fixing comprise a support element 2, solidly associable to the groove of the rim 101, and means for connecting predisposed to realize a reversible elastic coupling between the support element 2 and the internal panel 1. The presence of an elastic coupling enables considerable absorption of the vibrations which would be transmitted by the wheel to the internal panel 1 of the group in a case of a rigid coupling. The reversibility of the elastic coupling means that according to need the internal panel 1 can be decoupled from the support element 2. The support element 2, being operatively associated with the groove of the rim 101, will be distinguished between a coupled configuration of the group according to the invention, at which the internal board 1 is solidly constrained to the support element 2 and the rim 101 and an uncoupled configuration with the internal panel 1 disconnected from the rest of the group. The possibility of uncoupling the internal panel 1 from the rim 101 without having to dismount the support element 2 from the rim 101 means the internal panel 1 can be easily replaced.

The means for connecting predisposed to realize the reversible elastic coupling comprise elastic means and a unilateral constraint to relative motion between the support element 2 and the internal panel 1 which operates by opposing the action of the elastic means in the coupled group configuration. In the described embodiment, when the group is in the coupled configuration the action of the elastic means tends to push the internal panel 1 away from the rim 101 along a substantially perpendicular direction to an internal surface thereof, to which the support element 2 is solidly associated. The unilateral constraint to relative motion between the support element 1 and the internal panel 1 is constituted by parts of the two elements which are predisposed to interact contactingly in the coupled configuration, opposing the above-mentioned distancing of the internal panel 1 from the rim 101.

The support element 2 comprises a first plate, which is flexible and has a substantially arched profile, comprising a first median tract 3a associable to the inflation valve 102 of the tire, the concave surface of the first plate being predisposed to deform elastically in order to adapt to the convex surface of the groove of the rim 101. The first plate, preferably made of steel, is preferably constituted by the first planar median tract 3a, to ends of which two lower terminal tracts 3b, also planar, are associated; the lower terminal tracts 3b are inclined with respect to the median tract in order to determine the arched profile of the first plate. The first plate is symmetrical with respect to a transversal plane which crosses the first median plane 3a, as well as with respect to a longitudinal plane. For associating the median tract 3a to the inflation valve 102, the median plane exhibits a through-hole 7 close to the intersection of the two planes of symmetry of the first plate. The through-hole 7 is predisposed to be crossed by a threaded shank 8 of the inflation valve 102, arranged internally of the tire. The first plate is fixed to the rim 101 by screwing a nut 8a on the threaded shank 8, and thus of the support element 2 of which the first plate is a part. With the tightening of the nut 8a the elastic deformation of the first plate against the convex surface of the rim 101 groove is achieved; the inclination of the lower terminal tracts 3b will reduce up until it is adapted to the curvature of the surface. This construction solution enables the device of the invention to be adapted to rims having different diameters.

The support element 2 further comprises two lateral tabs 5a, associated to the ends of the first plate and arranged along planes that are substantially perpendicular to the convex surface of the first plate. The lateral tabs 5a are equal and symmetrically arranged with respect to the transversal plane of symmetry of the first plate.

In an alternative embodiment not illustrated in the enclosed figures of the drawings, the support element 2 comprises a rigid base instead of the first flexible plane, which base is predisposed to associate to the groove of the rim 101. In this embodiment, the lateral tabs 5a are associated to the ends of the rigid base.

The above-cited elastic means comprise a second plate 4, elastically deformable and having a substantially arched profile, comprising a second median tract 4a coupled to the first median tract 3a of the first plate, the convexity of the second plate 4 facing towards the first plate, the ends of the second plate being predisposed to come into contact with the internal panel 1 in a coupled configuration of the group. The second plate 4 is entirely similar to the first plate: it is preferably made of steel and is constituted by the planar second median tract 4a, at ends of which two planar upper terminal tracts are associated; the upper terminal tracts are inclined with respect to the median tract in order to generate the arched profile. The second plate is also symmetrical with respect to a transversal plane which crosses the second median tract 4a, and is also symmetrical with respect to a longitudinal plane. The first and the second plates 4 are coupled at the median tracts 3a, 4a thereof, two of the surfaces of the tracts being juxtaposed and reciprocally solidly constrained; consequently the through-hole 7 also crosses the second median tract 4a of the second plate 4. In a further embodiment, not illustrated, the two plates are realized with a common median tract from which the four above-described terminal tracts depart; the embodiment with juxtaposed and conjoined median tracts is however preferable for reasons of constructional simplicity. In a further embodiment, not shown in the figures, the elastic means comprise, alternatively or additionally to the second plate 4, at least a spring predisposed to insert between the internal panel 1 and the support element 2. The spring can be a simple compression helix spring, a Bellville washer, a pawl spring or a spring of another type. In a further embodiment, not illustrated in the figures, the elastic means comprise a deformable element predisposed to oppose the nearing of the internal panel 1 and the support element 2.

Summarizing the description of the first and second plate 4: the first median tract 3a of the first plate is planar; at ends thereof there are two lower terminal tracts 3b, symmetrically inclined and also planar; the second median tract 4a of the second plate 4 is also planar and is associated at two ends thereof to two upper terminal tracts symmetrically inclined and planar; the two plates have similar shape and dimensions; the first and the second median tract 3a, 4a when coupled are centrally passed through by a through-hole 7 for coupling the group to the inflation valve 102 of the tire. The unilateral constraint to relative motion between the support element 2 and the internal panel 1 comprises, in the embodiment described herein, at least two slots 5b present on the two lateral tabs 5a of the support element 2 and at least two hooking teeth 6a, arranged at the two ends of the internal panel 1 and predisposed to engage to the inside of the two slots 5b. It is clear that the unilateral constraint could be realized in the most varied ways, being sufficient to guarantee a point of contact between elements which are solidly constrained to the internal panel 1 which limits the relative motion between the two entities. In the preferred embodiment, the slots 5b are square or rectangular openings on the lateral tabs 5a; the hooking teeth are V-shaped and are advantageously provided with an inclined surface 13 facing externally with respect to the internal panel 1.

In a further embodiment, not illustrated in the accompanying figures of the drawings, the unilateral constraint in relative motion between the support element 2 and the internal panel 1 comprises projections of the two lateral tabs 5a of the support element 2 which are predisposed to associate to the shape of the internal panel 1. In this embodiment, it is not necessary to include the slots 5b and the hooking teeth 6a as described herein above.

The slots 5b are of such a shape and size as to enable, in a coupled configuration of the group, a movement of the internal panel 1 along a substantially perpendicular direction to the convex surface of the first plate, between at least a compressed position in which the internal panel 1 is in proximity of the first plate and the hooking teeth 6a are not engaged with the perimeter of the slots 5b, and an operating position in which the internal panel 1 is distanced with respect to the first plate and the hooking teeth 6a engage in contact with a part of the perimeter of the slots 5b. The elastic action exerted by the second plate 4 on the internal panel 4 is directed at maintaining the internal panel 1 in an operating position.

The internal panel 1 comprises a box container structure 9 substantially shaped as a rectangular parallelepiped. The length of the main dimension of the parallelepiped is substantially the same as the length of the first plate, and the surface of the parallelepiped facing towards the first plate is concave to follow the profile of the groove of the rim and to prevent interference there-with. The box container structure 9 is preferably made of a plastic material and is centrally perforated to enable passage of fluid (generally air) from and towards the opening of the inflation valve 102 in a coupled configuration of the described device; an antenna can be passed through the hole for transmitting data to the receiving panel.

The internal panel 1 comprises, internally of the box container structure 9, and apart from the at least a sensor 10, a battery 11 and means for sending radio messages towards an external panel (not shown in the figures of the drawings). A pressure surface 12 of the box container structure 9 opposite the surface of the parallelepiped directed towards the first plate is advantageously predisposed to easily exert pressure thereon. The hooking teeth 6a are associated to two of the opposite lateral surfaces of the box container structure 9.

In order to realize the coupling of the internal panel 1 with the support element 2 associated to an inflation valve 102, the hooking teeth 6a must be positioned at the lateral tabs 5a. First one of the two hooking teeth 6a is inserted in the corresponding slot 5b. The tooth is kept in contact with the perimeter of the slot by the elastic pressure exerted thereon by the second plate 4. Following this, as shown in FIG. 4, a pressure is exerted on the pressure surface 12 in proximity of the end of the internal panel 1 which is not yet engaged. This pressure causes a rotation of the panel about the hinge constituted by the tooth-slot joint at the engaged end and a consequent elastic deformation of the upper terminal tract of the second plate 4 against which the pressure is exerted. The sliding of the inclined surface 13 of the free tooth along the respective lateral tab 5a causes a flexion of the tab 5a, up until when the tooth inserts in the slot 5b and the lateral tab 5a returns into the non-deformed position. By releasing the pressure on the pressure surface 12, the upper terminal tract of the second plate 4 acts on the internal panel 1 while it elastically returns towards the original position, bringing the group into the above-mentioned operating position.

To return the group from the coupled configuration to the uncoupled configuration, it is sufficient to disengage the hooking teeth 6a from the respective slots 5b, the operation being facilitated by the flexibility of the lateral tabs 5a of the first plate on which the hooking teeth 6a are engaged.

What is claimed:

1). A group for measuring physical parameters relating to a state of a tire, comprising: an internal panel comprising at least a sensor, means for fixing for removably connecting the internal panel to a groove of a rim; wherein the means for fixing comprise: a support element, solidly associable to the rim, and means for connecting predisposed to realize a reversible elastic coupling between the support element and the internal panel.

2). The group of claim 1, wherein the means for connecting predisposed to realize a reversible elastic coupling comprise elastic means and a unilateral constraint to relative motion between the support element and the internal panel, which unilateral constraint opposes an action of the elastic means in a coupled configuration of the group.

3). The group of claim 2, wherein the support element comprises a first plate which is flexible and has an arched profile, which first plate comprises a first median tract associable to an inflation valve of the tire, a concave surface of the first plate being predisposed to elastically deform in order to adapt to a convex shape of the rim groove.

4). The group of claim 2 wherein the elastic means comprise a second plate which is elastically deformable and which has an arched profile, comprising a second median tract coupled to the first median tract of the first plate, a convexity of the second plate facing towards the first plate, ends of the second plate being predisposed to come into contact with the internal panel in a coupled configuration of the group.

5). The group of claim 4, wherein the support element comprises two lateral tabs associated to the end of the first plate and arranged along substantially perpendicular planes to a convex surface of the first plate.

6). The group of claim 5, wherein the unilateral constraint to relative motion between the support element (2) and the internal panel comprises at least two slots afforded in the two lateral tabs of the support element and at least two hooking teeth arranged at two ends of the internal panel and predisposed to engage internally of the slots.

7). The group of claim 6, wherein the slots are of such shape and size as to enable, in a coupled configuration of the group, a movement of the internal panel along a substantially perpendicular direction to the convex surface of the first plate, between at least a compressed position in which the internal panel is in proximity of the first plate and the hooking teeth are not engaged with a perimeter of the slots, and an operating position in which the internal panel is distanced from the first plate and the hooking teeth engage on contact with part of the perimeter of the slots, the elastic action exerted by the second plate on the internal panel being directed to maintaining the internal panel in the operating position.

8). The group of claim 7, wherein: the first median tract of the first plate is planar, at ends thereof being associated to lower terminal tracts symmetrically inclined and also planar; the second median tract of the second plate is also planar and is associated at two ends thereof to two upper terminal tracts, symmetrically inclined and planar.

9). The group of claim 8, wherein the first plate and the second plate are similar in shape and size, the first median tract and the second median tract when reciprocally coupled being centrally crossed by a through-hole for coupling the group to the inflation valve of the tire.

10). The group of claim 9, wherein the internal panel comprises a box container structure having a rectangular parallelepiped shape, a length of a main dimension of the parallelepiped being substantially equal to a length of the first plate, a surface of the parallelepiped facing towards the first plate being concave in order to follow a profile of the groove of the rim and to avoid interference therewith, the hooking teeth being associated to two opposite lateral surfaces of the box container structure.
